(19) United States
(12) Patent Application Publication
(10) Pub. No.: US 2019/0344888 A1
(43) Pub. Date: Nov. 14, 2019

(54) DEVICE, SYSTEM AND A METHOD FOR DOCKING A FLYING APPARATUS

(71) Applicant: INDOOR ROBOTICS LTD., RAMAT-GAN (IL)

(72) Inventors: DORON BEN-DAVID, RAMAT-GAN (IL); AMIT MORAN, TEL-AVIV (IL)

(21) Appl. No.: 16/351,557

(22) Filed: Mar. 13, 2019

(30) Foreign Application Priority Data
May 9, 2018 (IL) 259252

(51) Int. Cl. B64C 39/02; G05D 1/10

(52) U.S. Cl. CPC B64C 39/024; G05D 1/101

(57) ABSTRACT

A docking station for an aerial drone, including a base portion having a top surface, an alignment system positioned at the top surface of the base portion, having inclined wall portions extending downwards from the top surface to form a docking recess disposed in the top surface, configured to mechanically orient the aerial drone by sliding at least a portion of the aerial drone therein, a friction reducing mechanism, embedded or located on the inclined wall portions; and a connection module for connecting to the aerial drone upon landing.

### FIELD

The present invention relates to unmanned and drone aircraft and more specifically to docking devices for unmanned aircraft.

### BACKGROUND

The daily use of Unmanned Aerial Vehicles (UAVs), such as multirotor copters and similar vertical aircraft able to vertically take-off and land (VTOL), is constantly increasing. The VTOL UAVs (hereinafter: aerial drones) are used in a variety of fields such as photo shooting, deliveries and many other. Some of the aerial drones utilize an internal power source, which in some cases is rechargeable. The charging of the rechargeable power source is typically done by either connecting the aerial drones to a suitable docking station comprising or connected to a power source or connecting the aerial drones manually to a power source. The aerial drones may employ location and position mechanisms such as GPS, vision sensors, distance sensors and the like.

In order for the aerial drones to navigate to the docking station for charging the power source thereof, and/or exchange data, the aerial drones may use the location and position mechanisms. However, such location and position mechanisms may include positional errors that lead to misalignment of the aerial drone during the docking. Such misalignment may result in the drone connected inaccurately with the docking station, for example in terms of a physical or electromagnetic connection. Such inaccurate connection may prevent or limit data transfer and/or charging of the aerial drones' power source without manual intervention.

US2016001883 discloses systems and methods for autonomously landing an unmanned aerial vehicle (UAV). In particular, systems and methods described herein enable a UAV to land within and interface with a UAV ground station (UAVGS). In particular, one or more embodiments described herein include systems and methods that enable a UAV to conveniently interface with and land within a UAV ground station (UAVGS). For example, one or more embodiments include a UAV that includes a landing base and landing frame that interfaces with a landing housing of a UAVGS. U.S. Pat. No. 9,346,560 discloses Systems and methods for swapping the battery on an unmanned aerial vehicle (UAV). The UAV may be able to identify and land on an energy provision station autonomously. The UAV may take off and/or land on the energy provision station. The UAV may communicate with the energy provision station. The energy provision station may store and charge batteries for use on a UAV. WO2009028913 and KR20090002201 disclose docking stations for airplanes with friction means.

Therefore, there is a great need for improved docking systems and methods to reduce the need for manual intervention for fully-automated aerial drones.

### SUMMARY

The subject matter discloses a docking station for an aerial drone, comprising a base portion comprising a top surface, an alignment system positioned at the top surface of said base portion, comprising: inclined wall portions extending downwards from the top surface to form a docking recess disposed in said top surface, configured to mechanically orient a matching docker of said aerial drone by sliding at least a portion of the aerial drone therein; and a connection module for connecting to said aerial drone upon landing.

In some cases, the docking recess is in the shape of a concaved hemisphere. In some cases, the docking recess is in the shape of a triangular or rectangular pyramid. In some cases, the docking recess is in the shape of a cone. In some cases, the docking station further comprising a friction reducing mechanism, embedded/located on the inclined wall portions. In some cases, the friction reducing mechanism is comprised of smooth metal balls designed to allow smooth vertical spinning thereof. In some cases, the friction reducing mechanism is comprised of smooth metal cylinders designed to allow smooth vertical spinning thereof.

In some cases, the connection module comprises at least two conductive elements; and wherein a first conductive element of the at least two conductive elements is configured to serve as an electric terminal, and a second conductive element of the at least two conductive elements is configured to exchange signals.

The subject matter also discloses a system for landing an aerial drone in a docking station, comprising: a docking station comprising a base portion having a top surface, an alignment system comprising inclined wall portions extending from the top surface to form a docking recess disposed in said top surface, configured to orient landing of said aerial drone by sliding at least a portion of the aerial drone therein; and a connection module for connecting to said aerial drone upon landing; and, a matching portion configured to be attached to said aerial drone, said matching portion comprising a matching docker in a complimentary shape to the docking recess, wherein the matching docker is designed to fit inside the docking recess; a drone connector element configured to physically connect the matching portion to the aerial drone; a docking connector configured to electrically connect the aerial drone with the docking station.

In some cases, the matching portion is an integral component of the aerial drone. In some cases, the matching portion is a removable component of the aerial drone. In some cases, the docking recess is in the shape of a triangular or rectangular pyramid. In some cases, the docking recess is in the shape of a cone. In some cases, the docking station further comprising a friction reducing mechanism, embedded/located on the inclined wall portions.

In some cases, the friction reducing mechanism comprises of smooth metal balls designed to allow smooth vertical spinning thereof. In some cases, the friction reducing mechanism is comprised of smooth metal cylinders designed to allow smooth vertical spinning thereof. In some cases, each of the connection module of the docking station and the docking connector comprises of at least two conductive elements; and wherein a first conductive element of the at least two conductive elements is configured to serve as an electric terminal, and a second conductive element of the three conductive elements is configured to exchange signals.

The subject matter also discloses a method for landing an aerial drone having a matching portion in a docking station, comprising aerial drone starts the landing procedure by reaching to the docking station, the aerial drone hovers above the docking station and about the docking recesses comprising inclined wall portions; the aerial drone descends to the rim of the docking recess; the aerial drone shuts down its engine, thereby sliding across inclined wall portions of said docking recess; the aerial drone is electrically connected to the docking station.

### BRIEF DESCRIPTION OF THE DRAWINGS

The invention may be more clearly understood upon reading of the following detailed description of non-limiting exemplary embodiments thereof, with reference to the following drawings, in which:

FIGS. 1A-F disclose a docking station for landing an aerial drone thereon, according to exemplary embodiments of the subject matter,

FIGS. 2A-B discloses a matching portion configured to fit inside docking station, according to exemplary embodiments of the subject matter;

FIGS. 3A-3C discloses an aerial drone landing on a docking station, according to exemplary embodiments of the subject matter; and

FIGS. 4A-4B disclose a docking station comprising a friction reducing mechanism, according to exemplary embodiments of the subject matter.

The following detailed description of embodiments of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION

Illustrative embodiments of the invention are described below. In the interest of clarity, not all features/components of an actual implementation are necessarily described.

The subject matter in the present invention discloses landing an aerial drone on a docking station. The term “aerial drone” used herein depicts unmanned VTOLs such as multicopters. The term “hover” used herein is defined as maintaining a substantially fixed latitude over a specified surface.

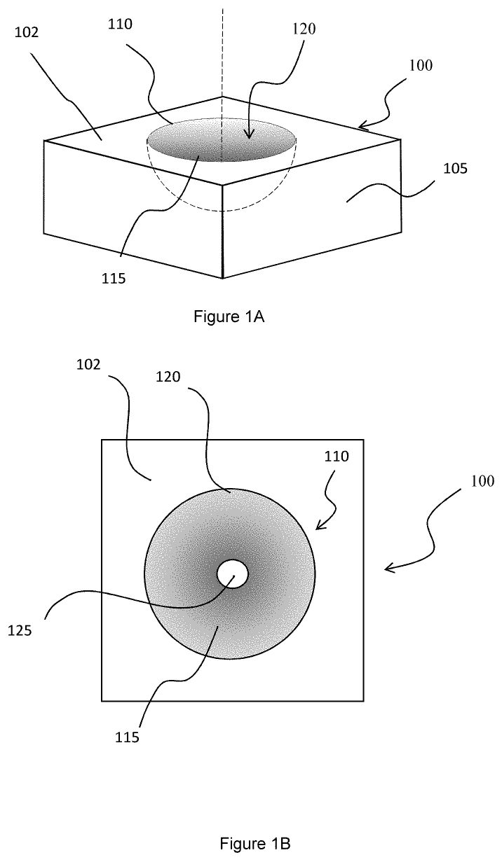

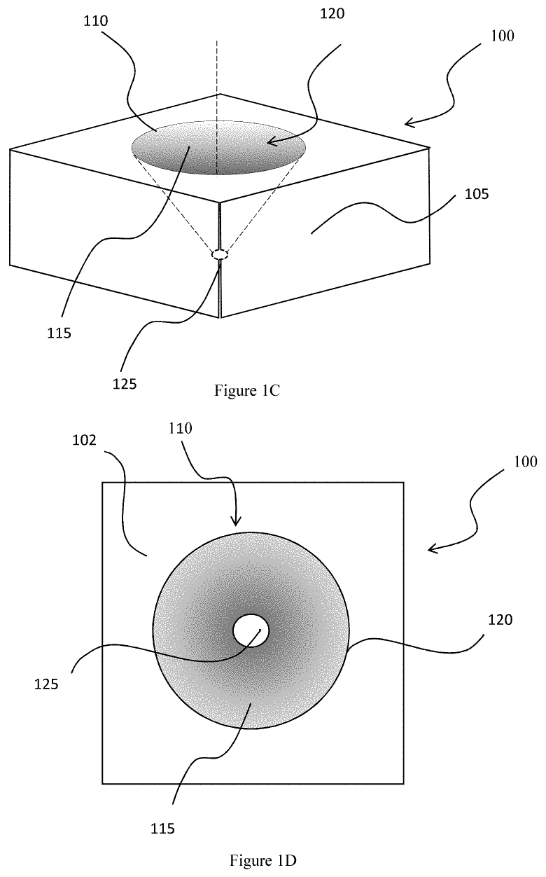

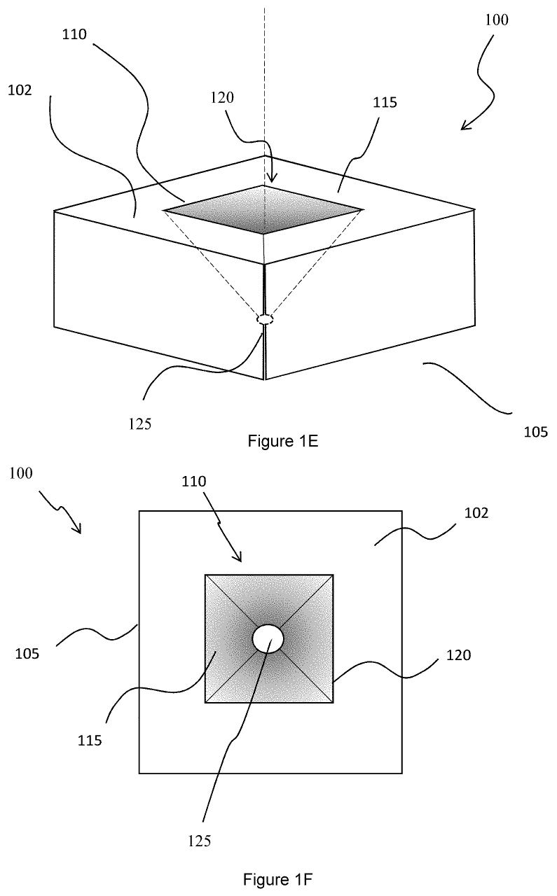

FIGS. 1A-F disclose a docking station for landing an aerial drone thereon, according to exemplary embodiments of the subject matter. FIG. 1A discloses a docking station 100 comprising: a base portion 105 having a top surface 102 and an alignment portion 110 disposed on the top surface 102 of base portion 105. In some embodiments, the alignment system 110 is configured to orient at least a portion of an aerial drone therein, thus enabling the aerial drone to land properly on the docking station 100. In further embodiments, the alignment system 110 is further configured to secure the aerial drone to the docking station 100.

In some embodiments, the alignment system 110 is located at the center of the top surface 102 of the base portion 105. In some embodiments, the alignment portion 110 comprising inclined wall portions 115, which are inclined towards the center of the base portion 105, creating a docking recess 120 inside base portion 105. The docking recess 120 enables facilitating the aerial drone to a desired location on the top surface 102 of the base portion 105 without requiring precise navigation of the aerial drone. The docking recess 120 surface area at the height of the top surface is equal to or larger than the surface area of the aerial drone.

In some embodiments, the docking recess 120 is shaped in a concave manner (hemisphere) such as in FIGS. 1A-1B. In other embodiments, the docking recess 120 is shaped in a conical manner, such as FIGS. 1C-1D, or a triangular or squared pyramid, such as in FIGS. 1E-1F. A connection module 125 comprising a docking charging module and a docking data exchange module, is placed at a central bottom location of the docking recess 120. The connection module 125 may constitute the meeting point of the inclined wall portions 115. In some embodiments, the data exchange module of connection module 125 is configured to communicate with the aerial drone via any suitable connection desired by a person skilled in the art, either wired or wireless. The charging module of connection module 125 is configured to provide energy to the aerial drone via an electrical connector, either wired or wireless.

In some embodiments, the connection module 125 may be comprised of 3 conductive elements, for example shaped as rings. The first conductive element serves as a positive electric terminal (+), the second ring serves as a negative electric terminal (−) and the third ring serves as a signal exchange terminal.

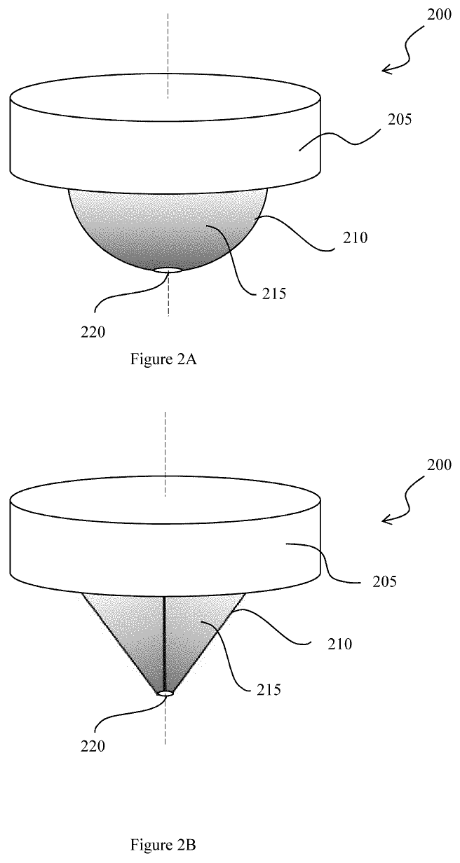

FIGS. 2A-B disclose a matching portion configured to fit a docking station, according to exemplary embodiments of the subject matter. As shown in FIG. 2A, a matching portion 200 comprising a drone connector element 205 and a matching docker 210 connected to the bottom side of drone connector element 205. In some embodiments, the drone connector elements 205 may be embedded as part of an aerial drone. In some embodiments, the drone connector element 205 may be attached to a surface (for example bottom surface) of the aerial drone as an add-on.

The matching docker 210 is configured to slidingly fit inside the docking recess 120 of the docking station 100. In some embodiments, the matching docker 210 has a physical shape that matches the physical shape of the docking recess 120, for example with an opposite matching inclined/concaved surface 215. For example, if the docking recess 120 is in the shape of a concave hemisphere, then the matching docker 210 would be shaped in a convex hemisphere as shown in FIG. 2A, and if the docking recess 120 is in the shape of a rectangular pyramid, then the matching docker 210 would also be shaped as a rectangular pyramid as shown in FIG. 2B. In further embodiments, the size of matching docker may be smaller than the size of the docking recess 120. In some embodiments, a docking connector 220 is located at the lowest portion of the matching docker 210. In some embodiments, the lowest portion of the matching docker 210 is located along a central vertical axis extending through the matching portion 200.

In some embodiments, the docking connector 220 comprises a docker charging module (not shown) configured to be connected, either wired or wirelessly, to the docking charging module for charging the power source of the aerial drone. In further embodiments, the docking connector 220 comprises a docker data exchange module (not shown) configured to be connected, either wired or wirelessly, to a docking data exchange module for exchanging data with the docking station 100.

In other embodiments, the matching portion 200 may be designed as an external add-on for existing aerial drones. In these cases, the drone connector 220 may comprise an electrical adapter extending therefrom for connecting the matching portion 200 to a power socket of the aerial drone. Thus, the add-on matching portion 200 enables charging the aerial drone by the docking station. In further cases, the matching portion 200 may comprise a data adapter designed to be connected to a data socket of the aerial drone. Additionally, the matching portion 200 may further comprise drone connecting elements (not shown), such as straps, screws and the like, for securing the matching portion to an aerial drone.

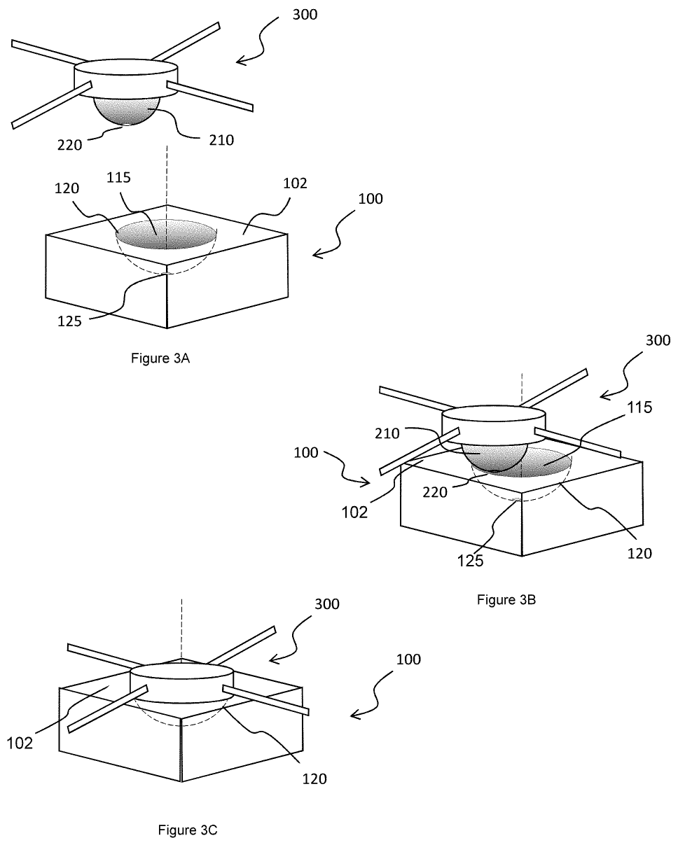

FIGS. 3A-3C discloses an aerial drone landing on a docking station, according to exemplary embodiments of the subject matter. FIG. 3A discloses an aerial drone 300 having a matching docker 210 hovering above and about the docking station 100. In order to land the aerial drone 300 in a precise manner resulting in the attachment of the docking connector 220 with the connection module 125, at least a portion of the matching docker 210 of the aerial drone 300 should be located above the docking recess 120. In some embodiments, the docking recess 120 may be wider than the matching docker 210 as long as the inclination of the inclined walls 115 thereof matches the inclination of the matching docker 210.

FIG. 3B shows the aerial drone 300 when a portion of the matching docker 210 is located inside the docking recess 120, for example in physical contact with the inclined wall portions 115. In some embodiments, the aerial drone 300 is configured to cease the hovering thereof upon contacting the inclined wall portions 115. When the aerial drone 300 stops hovering, the matching docker 210 is configured to slide down the inclined wall portions 115, until the docking connector 220 contacts the connection module 125. In some embodiments, the inclined wall portions 115 are covered by a friction reducing cover to ease the sliding of the aerial drone 300. FIG. 3C illustrates the aerial drone 300 connected to the docking station 100. In some embodiments, the matching docker 210 is fully engulfed within the docking recess 120. In other embodiments, the matching docker 210 may have portion thereof outside the docking recess 120 when fully connected to the docking station. In some embodiments, the aerial drone 100 rests on the upper surface 102 of the docking station.

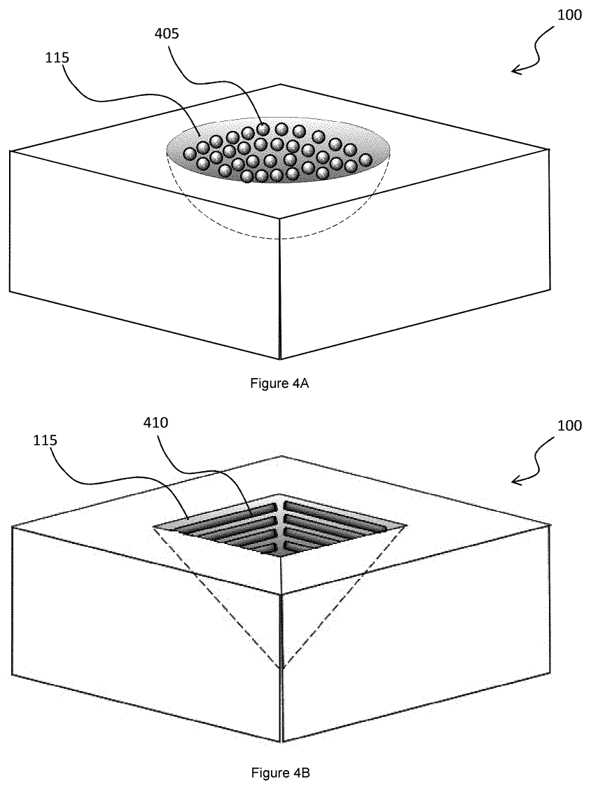

FIGS. 4A-4B disclose a docking station comprising a friction reducing mechanism, according to exemplary embodiments of the subject matter. In some embodiments, the inclined wall portions 115 of the docking station 100 comprise an integral friction reducing mechanism 400 therein. The friction reducing mechanism 400 may be connected to the inclined wall portions 115 using a mechanism such as adhesive material, nuts and bolts, hook and loop and any other manner for connecting one surface to another. FIG. 4A shows the friction reducing mechanism 400 comprising of smooth metal balls 405 having a desired coefficient of friction, according to some embodiments. In some cases, the metal balls 405 may be rotated vertically on an axis secured to the inclined wall portions 115. The metal balls 405 are designed to allow vertical spinning thereof for easing the fitting of the aerial drone inside the docking recess 120 while the aerial drone descend on the inclined wall portion 115. In further embodiments, as disclosed in FIG. 4B, the friction reducing mechanism is comprised of metal cylinders 410, dispersed horizontally on the inclined wall portions 115, and designed to allow vertical spinning thereof. By using the docking station 100 having the friction reducing mechanism 400, the matching docker of the aerial drone will slide easily down the inclined wall portions 115 to the docking connector.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

What is claimed is:

1. A docking station for an aerial drone, comprising:
a base portion comprising a top surface;
an alignment system positioned at the top surface of said base portion, comprising:
inclined wall portions extending downwards from the top surface to form a docking recess disposed in said top surface, configured to mechanically orient said aerial drone by sliding at least a portion of the aerial drone therein;
a friction reducing mechanism, embedded or located on the inclined wall portions; and
a connection module for connecting to said aerial drone upon landing.

2. The docking station of claim 1, wherein the docking recess is in the shape of a concaved hemisphere.

3. The docking station of claim 1, wherein the docking recess is in the shape of a triangular or rectangular pyramid.

4. The docking station of claim 1, wherein the docking recess is in the shape of a cone.

5. The docking station of claim 1, wherein the friction reducing mechanism is comprised of smooth metal balls designed to allow smooth vertical spinning thereof.

6. The docking station of claim 1, wherein the friction reducing mechanism is comprised of smooth metal cylinders designed to allow smooth vertical spinning thereof.

7. The docking station of claim 1, wherein the connection module comprises at least two conductive elements, and wherein a first conductive element of the at least two conductive elements is configured to serve as an electric terminal, and a second conductive element of the at least two conductive elements is configured to exchange signals.

8. A system for landing an aerial drone in a docking station, comprising:
a docking station comprising a base portion having a top surface, an alignment system comprising inclined wall portions extending from the top surface to form a docking recess disposed in said top surface, configured to orient landing of said aerial drone by sliding at least a portion of the aerial drone therein; and
a connection module for connecting to said aerial drone upon landing; and,
a matching portion configured to be attached to said aerial drone, said matching portion comprising a matching docker in a complimentary shape to the docking recess, wherein the matching docker is designed to fit inside the docking recess;
a drone connector element configured to physically connect the matching portion to the aerial drone;
a docking connector configured to electrically connect the aerial drone with the docking station;
wherein the docking station further comprising a friction reducing mechanism, embedded or located on the inclined wall portions.

9. The system of claim 8, wherein the matching portion is an integral component of the aerial drone.

10. The system of claim 8, wherein the matching portion is a removable component of the aerial drone.

11. The system of claim 8, wherein the docking recess is in the shape of a triangular or rectangular pyramid.

12. The system of claim 8, wherein the docking recess is in the shape of a cone.

13. The system of claim 8, wherein the friction reducing mechanism is comprised of smooth metal balls designed to allow smooth vertical spinning thereof.

14. The system of claim 8, wherein the friction reducing mechanism is comprised of smooth metal cylinders designed to allow smooth vertical spinning thereof.

15. The system of claim 14, wherein each of the connection module of the docking station and the docking connector comprises of at least two conductive elements; and wherein a first conductive element of the at least two conductive elements is configured to serve as an electric terminal, and a second conductive element of the three conductive elements is configured to exchange signals.
